(19) United States
(12) Patent Application Publication
(10) Pub. No.: US 2025/0295075 A1
(43) Pub. Date: Sep. 25, 2025

(54) Pick-up Apparatus for an Agricultural Harvester

(71) Applicant: CLAAS Saulgau GmbH, 88348 Bad Saulgau (DE)

(72) Inventors: Christian König, Oberteuringen (DE); Christoph Kaufmann, Hohentengen (DE)

(21) Appl. No.: 19/084,374

(22) Filed: Mar. 19, 2025

(30) Foreign Application Priority Data
Mar. 20, 2024 (DE) 102024107962.2

(51) Int. Cl. A01D 89/00

(52) U.S. Cl. CPC A01D 89/008; A01D 89/001

(57) ABSTRACT

A pick-up apparatus (10) for an agricultural harvester, with a main frame (11) designed to connect the pick-up apparatus (10) to the agricultural harvester, with a crop collector (12) which is attached to the main frame (11), the crop collector (12) being designed to pick up crops from a ground surface, and with a crop conveyor (13), which is attached to the main frame (11) via brackets (14) in such a way that the crop conveyor (13) is mounted rotatably on the brackets (14) and is pivotable together with the brackets (14) in relation to the main frame (11), wherein the crop conveyor (13) is designed, in conjunction with a floor plate (19), to convey the crops picked up by the crop collector (12), wherein at least one eccentric body (20) is attached to the main frame (11), on which body a respective bracket (14) is directly or indirectly supported, wherein the position of the at least one eccentric body (20) on the main frame (11) determines the distance between the crop conveyor (13) and the floor plate (19). FIG. 1

The invention relates to a pick-up apparatus for an agricultural harvester.

DE 10 2012 011 574 B4 discloses a pick-up apparatus for an agricultural harvester. The pick-up apparatus has a main frame designed to connect the pick-up apparatus to the agricultural harvester. In addition, the pick-up apparatus comprises a crop collector and a crop conveyor. The crop collector is attached to the main frame and is designed to pick up the crops from a ground surface. The crop conveyor is fastened pivotably to the main frame via brackets. In conjunction with a floor plate, the crop conveyor is designed to convey the crops picked up by the crop collector.

It has hitherto been difficult to set a desired distance between the crop conveyor and the floor plate or a conveying floor. However, setting the distance between the crop conveyor and the crop collector is important for the proper transport of the collected crops, especially in the transfer region between the crop collector and the crop conveyor in the area of the floor plate positioned there.

DE 10 2012 011 591 C5 discloses another pick-up apparatus for an agricultural harvester with a crop collector and a crop conveyor.

Proceeding from this, the object of the present invention is to provide a novel pick-up apparatus for an agricultural harvester.

This object is achieved by a pick-up apparatus for an agricultural harvester, according to claim 1.

According to the invention, at least one eccentric body is attached to the main frame, on which body a respective bracket is directly or indirectly supported, wherein the position of the at least one eccentric body determines the distance between the crop conveyor and the floor plate.

The distance between the crop conveyor and the floor plate can be easily changed via the at least one eccentric body. During use of the pick-up apparatus in the field, by simply changing the position of the respective eccentric body on the main frame, it is possible to change the distance between the crop conveyor and the floor plate or crop collector. No additional assemblies are required for this purpose. It is simply necessary to change the mounting position of the eccentric body on the main frame.

Preferably, at least one recess is formed on the main frame, in which recess a respective eccentric body engages positively with a projection in one of several possible positions, in particular in one of two possible positions, and is fastened to the main frame, wherein the position in which the projection of the respective eccentric body engages in the respective recess determines the distance between the crop conveyor and the floor plate. This permits a particularly simple change of the distance between the crop conveyor and the floor plate.

Preferably, cheeks are formed on the main frame below the brackets mounted pivotably on the main frame, wherein a recess for receiving the projection of a respective eccentric body and for fastening the latter to the main frame is formed on each of the cheeks. The respective eccentric body, when its projection engages in the respective recess, is fastened to the respective cheek of the main frame via a screw. Again, this permits a particularly simple change of the distance between the crop conveyor and the floor plate.

Preferably, the respective eccentric body has a base body having the projection, wherein the projection lies eccentrically on the base body. In particular, the eccentric body moreover has a roller body which is rotatable relative to the base body and which radially surrounds the outside of the base body. When the eccentric body has the rotatable roller body, the risk of damage to the eccentric body and to the brackets for the crop conveyor resting directly or indirectly on the eccentric body is reduced.

Preferred developments of the invention can be gathered from the dependent claims and from the following description. Exemplary embodiments of the invention are explained in more detail on the basis of the drawing, without being limited thereto. In the drawing:

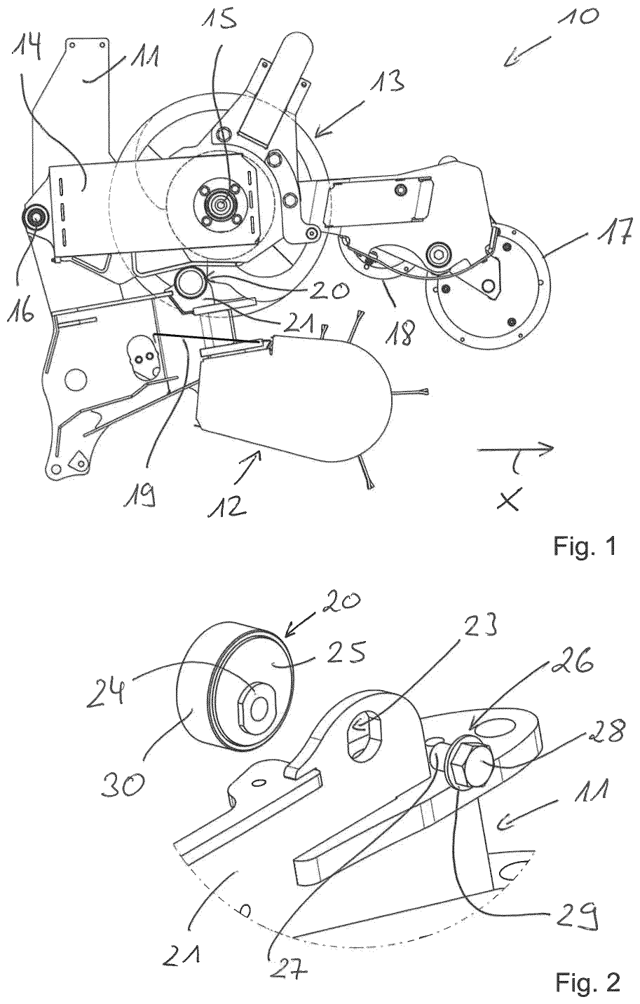

FIG. 1 shows a side view of a pick-up apparatus according to the invention for an agricultural harvester in a first state thereof,

FIG. 2 shows a detail of FIG. 1 in a perspective exploded view,

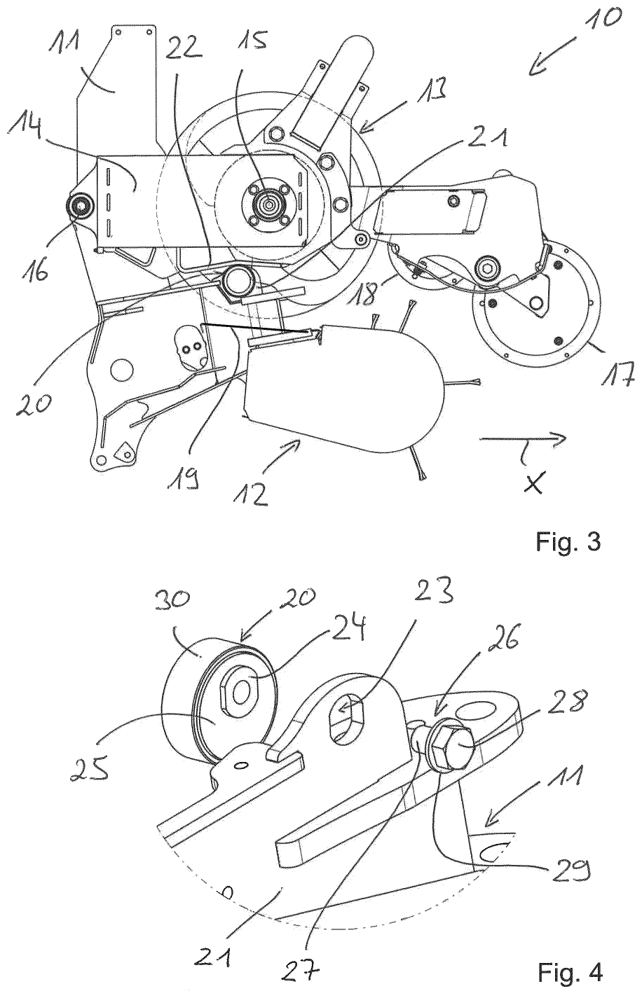

FIG. 3 shows a side view of the pick-up apparatus according to the invention for an agricultural harvester in a second state thereof,

FIG. 4 shows a detail of FIG. 3 in a perspective exploded view.

FIGS. 1 and 3 show a side view of a pick-up apparatus 10 according to the invention for an agricultural harvester.

The pick-up apparatus 10 has a main frame 11 designed to connect the pick-up apparatus 10 to an agricultural harvester. The pick-up apparatus 10 further comprises a crop collector 12 and a crop conveyor 13, with FIGS. 1 and 3 differing in terms of the distance between the crop conveyor 13 of the pick-up apparatus 10 and a floor plate 19 of the pick-up apparatus 10. The floor plate 19 is arranged on the crop collector 12 and forms a conveying floor for the crop conveyor 13.

The crop collector 12 of the pick-up apparatus 10 is attached to the main frame 11, the crop collector 12 being designed to pick up crops from a ground surface.

The crop conveyor 13 of the pick-up apparatus 10 is mounted rotatably on brackets 14 and is pivotably attached to the main frame 11 via the brackets 14. FIGS. 1 and 3 show an axis of rotation 15, about which the crop conveyor 13 is mounted rotatably on the brackets 14, wherein a bracket 14 is arranged at both lateral ends of the crop conveyor 13. Furthermore, FIGS. 1 and 3 show a pivot axis 16, about which the brackets 14, and via the brackets 14 the crop conveyor 13, are pivotable relative to the main frame 11.

Furthermore, FIGS. 1 and 3 show hold-down rollers 17, 18 of the pick-up apparatus 10. The hold-down rollers 17, 18, like the crop conveyor 13, are mounted pivotably on the frame 11, specifically together with the crop conveyor 13 via the lateral brackets 14. During operation, the hold-down rollers 17, 18 lie on top of a windrow of crop material and, by holding down the windrow, ensure that the crop material can be picked up fully by the crop collector 12 and can reach the crop conveyor 13.

FIG. 1 shows, in a transfer region between the crop collector 12 and the crop conveyor 13, the floor plate 19, which is arranged below the crop conveyor 13 between the crop collector 12 and the main frame 11. The crop conveyor 13, which is designed as a cross auger, conveys the crop, in conjunction with the floor plate 19, to a central region of the pick-up apparatus 10, where it is passed on to the harvester.

During operation, the pick-up apparatus 10 is moved by the agricultural harvester in the direction of travel X, such that the floor plate 19, seen in this direction of travel X, is arranged behind the crop collector 12.

To be able to easily adjust the distance between the crop conveyor 13 and the floor plate 19, at least one eccentric body 20 is attached to the main frame 11.

In particular, an eccentric body 20 is attached to side cheeks 21 of the main frame 11, which are arranged below the lateral brackets 14 engaging pivotably on the main frame 11 for the crop conveyor 13, wherein the respective bracket 14 rests directly or indirectly on the respective eccentric body 20.

In FIGS. 1 and 3, the respective bracket 14 rests indirectly on the respective eccentric body 20 via a support element 22 fastened to the bracket 14.

The position in which the respective eccentric body 20 is attached to the main frame 11 of the pick-up apparatus 10 determines the distance between the crop conveyor 13 of the pick-up apparatus 10 and the crop collector 12 of the pick-up apparatus 10 or between the crop conveyor 13 and the floor plate 19 or the conveying floor.

Recesses 23 are formed on the side cheeks 21 (shown in particular in FIGS. 2 and 4) of the main frame 11 of the pick-up apparatus 10. A respective eccentric body 20 with a projection 24 engages positively in these recesses 23 in one of several possible positions, preferably in one of two possible positions. The position in which the projection 24 of the respective eccentric body 20 engages in the respective recess 23 and is then fastened to the main frame 11 determines the distance between the crop conveyor 13 and the crop collector 12 or the distance between the crop conveyor 13 and the conveyor plate 19.

FIG. 4 shows the position for fastening the eccentric body 20 to the main frame 11, with which the relatively small distance shown in FIG. 3 can be set between the crop conveyor 13 and the floor plate 19. FIG. 2 shows the mounting position for the respective eccentric body 20 on the main frame 11, with which the relatively large distance shown in FIG. 1 can be provided between the crop conveyor 13 and the floor plate 19. In the region of both side cheeks 21 of the main frame 11, the same mounting position is selected for the respective eccentric body 20 on the main frame 11.

As has already been stated, the respective eccentric body 20 has the projection 24 which, in its respective mounting position on the main frame 11, positively engages in the respective recess 23 of the respective cheek 21 of the main frame 11. This projection 24 is formed on a base body 25 of the respective eccentric body 20 and lies eccentrically on the respective base body 25. The base body 25 is cylindrical in the exemplary embodiment shown. The projection 24 is spaced apart from the longitudinal center axis of the cylindrical base body 25, so that the eccentric position of the projection 24 on the base body 25 is provided.

Projection 24 and recess 23 are contoured in such a way that, in the exemplary embodiment shown, the eccentric body 20 can be mounted on the respective cheek 21 in only one of two possible positions, which are at 180° to each other. It is also possible for contour projection 24 and recess 23 to be contoured in such a way that the eccentric body 20 can be mounted on the respective cheek 21 in only one of three or four possible positions, which are at 120° or 90° to each other. The number of possible positions for fastening the respective eccentric body 20 to the respective cheek 21 preferably corresponds to the number of available different distances between the crop conveyor 13 and the crop collector 12.

The eccentric body 20 engages with its projection 24 into the respective recess 23 of the cheek 21 from a first side of the cheek 21. From an opposite side of the cheek 21, the respective eccentric body 20 is mounted on the respective cheek 21 of the main frame 11 via a fastening screw 26, wherein for this purpose a threaded shaft 27 of the fastening screw 26 engages in the projection 24 of the respective eccentric body 20, and a screw head 28 of the fastening screw 26 is supported on the respective cheek 21, in particular via a washer 29.

In the exemplary embodiment shown, as has already been explained above, the respective bracket 14 rests on the respective eccentric body 20 indirectly via the respective support element 22. The respective bracket 14 can also rest directly on the respective eccentric body 20.

In the preferred exemplary embodiment shown, the respective eccentric body 20 has, in addition to the base body 25 and to the projection 24 formed on the base body 25, a roller body 30 which is rotatable relative to the base body 25. The roller body 30 radially surrounds the outside of the base body 25 and is in the form of a ring. By virtue of the rotatability of the roller body 30 relative to the base body 25 of the respective eccentric body 20, it is possible to ensure particularly advantageous indirect or direct support of the respective bracket 14 on the respective eccentric body 20 while minimizing a risk of damage.

The position of the respective eccentric body 20 on the respective cheek 21 of the main frame 11 can be easily changed in the field. For this purpose, the respective fastening screw 26 simply has to be loosened, the position of the eccentric body 20 on the cheek 21 changed, and subsequently the fastening screw 26 tightened again. This is possible within a short time in the field. Thus, the distance between the crop conveyor 13 and the crop collector 12 or the conveyor plate 19 can be easily adapted in the field to different windrow heights.

### LIST OF REFERENCE SIGNS

10 pick-up apparatus
11 main frame
12 crop collector
13 crop conveyor
14 bracket
15 axis of rotation
16 pivot axis
17 hold-down roller
18 hold-down roller
19 floor plate
20 eccentric body
21 cheek
22 support element
23 recess
24 projection
25 base body
26 fastening screw
27 threaded shaft
28 screw head
29 washer
30 roller body

1. A pick-up apparatus (10) for an agricultural harvester,
with a main frame (11) designed to connect the pick-up apparatus (10) to the agricultural harvester,
with a crop collector (12) attached to the main frame (11), the crop collector (12) being designed to pick up crops from a ground surface, and
with a crop conveyor (13), which is attached to the main frame (11) via brackets (14) in such a way that the crop conveyor (13) is mounted rotatably on the brackets (14) and is pivotable together with the brackets (14) in relation to the main frame (11), wherein the crop conveyor (13) is designed, in conjunction with a floor plate (19), to convey the crops picked up by the crop collector (12),
characterized in that
at least one eccentric body (20) is attached to the main frame (11), on which body a respective bracket (14) is directly or indirectly supported, wherein the position of the at least one eccentric body (20) on the main frame (11) determines the distance between the crop conveyor (13) and the floor plate (19).

2. The pick-up apparatus (10) according to claim 1, characterized in that
at least one recess (23) is formed on the main frame (11), in which recess a respective eccentric body (20) engages positively with a projection (24) in one of several possible positions, wherein the position in which the projection (24) of the respective eccentric body (20) engages in the respective recess (23) determines the distance between the crop conveyor (13) and the floor plate (19).

3. The pick-up apparatus (10) according to claim 2, characterized in that
a respective eccentric body (20) with the projection (24) engages positively in the respective recess (23) in one of two possible positions.

4. The pick-up apparatus (10) according to claim 2, characterized in that
the respective eccentric body (20) has a base body (25) having the projection (24), wherein the projection (24) lies eccentrically on the base body (25).

5. The pick-up apparatus (10) according to claim 4, characterized in that
the respective eccentric body (20) has a roller body (30) which is rotatable relative to the base body (25) and which radially surrounds the outside of the base body (25).

6. The pick-up apparatus (10) according to claim 2, characterized in that
cheeks (21) are formed on the main frame (11), below the brackets (14) pivotably mounted on the main frame (11), and
a respective recess (23) for receiving the projection (24) of a respective eccentric body (20) is formed on the cheeks (21).

7. The pick-up apparatus (10) according to claim 6, characterized in that
the respective eccentric body (20), when its projection (24) engages in the respective recess (23), is fastened to the respective cheek (21) of the main frame (11) via a screw (26).

8. The pick-up apparatus (10) according to claim 7, characterized in that
the projection (24) of a respective eccentric body (20) extends into the recess (23) of the respective cheek (21) from a first side of the latter, and
a threaded shaft (27) of a respective screw (26) extends into the projection (24) of the respective eccentric body (20) from a second side of the respective cheek (21) and is supported on the respective cheek (21) with a screw head (28).
